(19) United States
(12) Patent Application Publication
(10) Pub. No.: US 2025/0298711 A1
(43) Pub. Date: Sep. 25, 2025

(54) ARITHMETIC CIRCUIT, MEMORY SYSTEM, AND METHOD OF CONTROLLING NONVOLATILE MEMORY

(71) Applicant: Kioxia Corporation, Tokyo (JP)

(72) Inventors: Hironori UCHIKAWA, Fujisawa (JP); Yuki KONDO, Yokohama (JP); Naoaki KOKUBUN, Yokohama (JP)

(73) Assignee: Kioxia Corporation, Tokyo (JP)

(21) Appl. No.: 18/974,922

(22) Filed: Dec. 10, 2024

(30) Foreign Application Priority Data
Mar. 19, 2024 (JP) 2024-043063

(51) Int. Cl. G06F 11/28; G06F 17/16

(52) U.S. Cl. CPC G06F 11/28; G06F 17/16

(57) ABSTRACT

According to one embodiment, an arithmetic circuit includes a matrix calculator and p or more evaluators. The matrix calculator calculates a matrix that corresponds to a linearized polynomial included in an affine polynomial obtained by decomposing an error locator polynomial. Each of the evaluators calculates a first multiplication result obtained by multiplying the matrix by a first multiplication value based on a substitution value to be substituted into the error locator polynomial, calculates, for each of one or more evaluation terms that are different from the linearized polynomial, a second multiplication result obtained by multiplying a second multiplication value based on the substitution value by a corresponding evaluation term, and outputs error position information based on a value obtained by adding the first multiplication result and the second multiplication result.

### CROSS-REFERENCE TO RELATED APPLICATIONS

This application is based upon and claims the benefit of priority from Japanese Patent Application No. 2024-043063, filed on Mar. 19, 2024; the entire contents of which are incorporated herein by reference.

### FIELD

Embodiments described herein relate generally to an arithmetic circuit, a memory system, and a control method.

### BACKGROUND

In a memory system, data having been subjected to error correction encoding is stored in a memory such as a NAND flash memory in order to protect the data stored in the memory. Therefore, when the data stored in the memory is read, the data (also referred to as received word) having been subjected to error correction encoding that has been read from the memory is decoded to restore data before the error correction encoding.

For an error correction code, a decoding technique using an error locator polynomial is known. The Chien search is known, for example, as a method of calculating an error position by using the error locator polynomial. The Chien search is a method of sequentially substituting values into the error locator polynomial and searching for the error position based on a value at which an output value of the error locator polynomial becomes 0. In decoding processing, the size of an arithmetic circuit for searching for a root of the error locator polynomial, such as the Chien search, tends to increase.

### BRIEF DESCRIPTION OF THE DRAWINGS

FIG. 1 is a block diagram of a memory system according to an embodiment;

FIG. 2 is a block diagram of a decoder according to the embodiment;

FIG. 3 is a diagram illustrating a configuration example of an error position calculator in which substitution processing has been parallelized;

FIG. 4 is a diagram illustrating a configuration example of an error position calculator;

FIG. 5 is a diagram illustrating a configuration example of the error position calculator;

FIG. 6 is a diagram illustrating a configuration example of a Δ₀^{(j)} calculator;

FIG. 7 is a diagram for explaining an example of matrix multiplication in an evaluator;

FIG. 8 is a diagram illustrating a configuration example of the error position calculator;

FIG. 9 is a diagram illustrating a configuration example of a Δ₁^{(j)} calculator;

FIG. 10 is a flowchart of decoding processing according to the embodiment;

FIG. 11 is a diagram illustrating a configuration example of an error position calculator according to a second embodiment; and

FIG. 12 is a diagram illustrating a configuration example of a chain-type Δ₁^{(j)} calculator.

### DETAILED DESCRIPTION

In general, according to one embodiment, an arithmetic circuit includes a matrix calculator and p or more evaluators. The matrix calculator calculates one or more matrices that correspond to one or more linearized polynomials included in one or more affine polynomials obtained by decomposing an error locator polynomial for an error correction code having a code length of n bits (n is an integer of 2 or more). The evaluators calculate, for each of the one or more matrices, a first multiplication result obtained by multiplying a corresponding matrix by a first multiplication value based on a substitution value to be substituted into the error locator polynomial, calculate, for each of one or more evaluation terms that are included in the one or more affine polynomials and are different from the one or more linearized polynomials, a second multiplication result obtained by multiplying a second multiplication value based on the substitution value by a corresponding evaluation term, and output error position information based on a value obtained by adding the first multiplication result and the second multiplication result. The p or more evaluators calculate the error position information by using a plurality of the substitution values that are different from each other.

Exemplary embodiments of an arithmetic circuit will be described below in detail with reference to the accompanying drawings. The description below will be provided by using, as an example, a memory system including an arithmetic circuit that searches for a root of an error locator polynomial at the time of decoding an error correction code. A configuration employing the arithmetic circuit is not limited to this example, and any system (apparatus or device) may be employed.

### First Embodiment

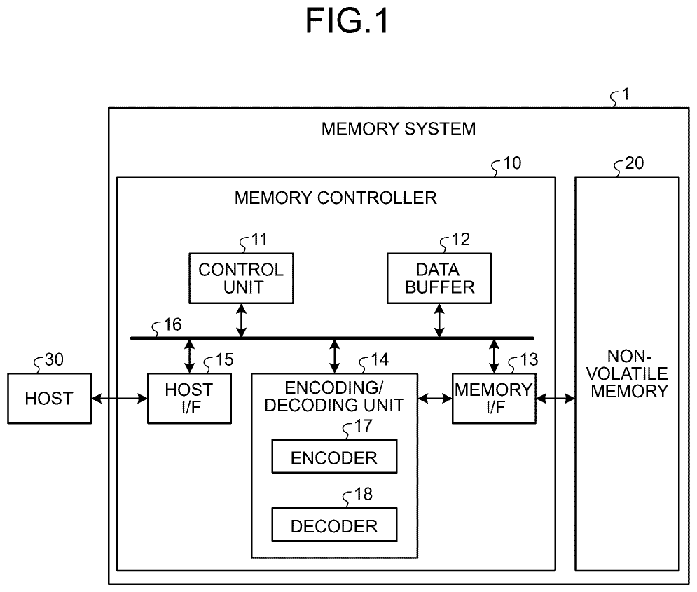

First, a memory system according to the present embodiment will be described in detail with reference to the drawings. FIG. 1 is a block diagram illustrating a schematic configuration example of the memory system according to the present embodiment. As illustrated in FIG. 1, a memory system 1 includes a memory controller 10 and a nonvolatile memory 20. The memory system 1 is connectable to a host 30, and FIG. 1 illustrates a state where the memory system 1 is connected to the host 30. The host 30 may be, for example, an electronic device such as a personal computer or a mobile terminal.

The nonvolatile memory 20 is a nonvolatile memory that stores data in a nonvolatile manner, and the nonvolatile memory 20 is, for example, a NAND flash memory (hereinafter simply referred to as a NAND memory). In the description below, a case where the NAND memory is used as the nonvolatile memory 20 will be exemplified. However, a storage device other than the NAND memory, such as a three-dimensional structure flash memory, a resistive random access memory (ReRAM), or a ferroelectric random access memory (FeRAM), can be used as the nonvolatile memory 20. Additionally, the nonvolatile memory 20 is not necessarily a semiconductor memory, and the present embodiment can also be applied to various storage media other than the semiconductor memory.

The memory system 1 may be various memory systems including the nonvolatile memory 20, such as what is called a solid state drive (SSD) or a memory card in which the memory controller 10 and the nonvolatile memory 20 are configured as one package.

The memory controller 10 controls writing to the nonvolatile memory 20 in accordance with a write request from the host 30. In addition, the memory controller 10 controls reading from the nonvolatile memory 20 in accordance with a read request from the host 30. The memory controller 10 is, for example, a semiconductor integrated circuit configured as a system on a chip (SoC). The memory controller 10 includes a host interface (host I/F) 15, a memory interface (memory I/F) 13, a control unit 11, an encoding/decoding unit (codec) 14, and a data buffer 12. The host I/F 15, the memory I/F 13, the control unit 11, the encoding/decoding unit 14, and the data buffer 12 are mutually connected by an internal bus 16. Some or all of the operations of respective components of the memory controller 10 that will be described below may be implemented by a central processing unit (CPU) executing firmware, or may be implemented by hardware.

The host I/F 15 performs processing according to a standard of an interface with the host 30, and outputs, to the internal bus 16, a command received from the host 30, user data to be written, or the like. In addition, the host I/F 15 transmits, to the host 30, user data that has been read from the nonvolatile memory 20 and has been restored, a response from the control unit 11, or the like.

The memory I/F 13 performs processing for writing to the nonvolatile memory 20 in accordance with an instruction from the control unit 11. In addition, the memory I/F 13 performs processing for reading from the nonvolatile memory 20 in accordance with an instruction from the control unit 11.

The control unit 11 integrally controls the respective components of the memory system 1. In a case where the control unit 11 has received a command from the host 30 via the host I/F 15, the control unit 11 performs control according to the command. In one example, the control unit 11 instructs the memory I/F 13 to write the user data and parity to the nonvolatile memory 20 in accordance with a command from the host 30. In addition, the control unit 11 instructs the memory I/F 13 to read the user data and the parity from the nonvolatile memory 20 in accordance with a command from the host 30.

In a case where the control unit 11 has received a write request from the host 30, the control unit 11 determines a storage area (a memory area) on the nonvolatile memory 20 for the user data accumulated in the data buffer 12. Thus, the control unit 11 manages a write destination of the user data. The correspondence between a logical address of user data received from the host 30 and a physical address indicating the storage area on the nonvolatile memory 20, where the user data has been stored, is stored as an address conversion table.

In addition, in a case where the control unit 11 has received a read request from the host 30, the control unit 11 converts a logical address designated by the read request into a physical address by using the address conversion table described above, and instructs the memory I/F 13 to perform reading from the physical address.

In the NAND memory, generally, writing and reading are performed in data units called pages, and erasing is performed in data units called blocks. In the present embodiment, a plurality of memory cells connected to the same word line is referred to as a memory cell group. In a case where the memory cell is a single level cell (SLC), one memory cell group corresponds to one page. In a case where the memory cell is a multiple level cell (MLC), one memory cell group corresponds to a plurality of pages. In the present description, the MLC includes a triple level cell (TLC), a quad level cell (QLC), and the like. Each of the memory cells is connected to a word line, and is also connected to a bit line. Therefore, each of the memory cells can be identified by an address for identifying the word line and an address for identifying the bit line.

The data buffer 12 temporarily stores the user data received from the host 30 by the memory controller 10, until the user data is stored in the nonvolatile memory 20. In addition, the data buffer 12 temporarily stores the user data read from the nonvolatile memory 20, until the user data is transmitted to the host 30. The data buffer 12 can be implemented by a general-purpose memory such as a static random access memory (SRAM) or a dynamic random access memory (DRAM). Note that the data buffer 12 may be provided outside the memory controller 10 without being incorporated into the memory controller 10.

The user data transmitted from the host 30 is transferred to the internal bus 16, and is temporarily stored in the data buffer 12. The encoding/decoding unit 14 encodes the user data stored in the nonvolatile memory 20 to generate a code word. Furthermore, the encoding/decoding unit 14 decodes a received word serving as data read from the nonvolatile memory 20 to restore the user data. Therefore, the encoding/decoding unit 14 includes an encoder 17 and a decoder 18. Note that data to be encoded by the encoding/decoding unit 14 may include control data or the like that is used inside the memory controller 10 in addition to the user data.

Next, the write processing of the present embodiment will be described. The control unit 11 instructs the encoder 17 to encode the user data at the time of writing to the nonvolatile memory 20. At this time, the control unit 11 determines a storage location (a storage address) of a code word in the nonvolatile memory 20, and also provides the memory I/F 13 with an instruction relating to the determined storage location.

The encoder 17 encodes the user data on the data buffer 12 in accordance with the instruction from the control unit 11 to generate the code word. As an encoding method, for example, an encoding method using algebraic codes such as Bose-Chaudhuri-Hocquenghem (BCH) codes or Reed-Solomon (RS) codes, and an encoding method (product codes or the like) using these codes as component codes in a row direction and a column direction can be adopted. The memory I/F 13 performs control to store the code word in the storage location on the nonvolatile memory 20 that is indicated in the instruction from the control unit 11. The description below will be provided by using, as an example, a case where a BCH code for correcting an error of t bits or less is used.

Next, processing at the time of reading from the nonvolatile memory 20 of the present embodiment will be described. At the time of reading from the nonvolatile memory 20, the control unit 11 designates an address on the nonvolatile memory 20, and instructs the memory I/F 13 to perform reading. The control unit 11 also instructs the decoder 18 to start decoding. The memory I/F 13 reads data from the designated address on the nonvolatile memory 20 in accordance with an instruction of the control unit 11, and inputs the read data as a received word to the decoder 18. The decoder 18 decodes the received word serving as the data read from the nonvolatile memory 20.

The decoder 18 decodes the received word serving as the data read from the nonvolatile memory 20. The decoder 18 calculates an error locator polynomial by using, for example, the Peterson-Gorenstein-Zierler (PGZ) method, the Berlekamp-Massey (BM) method, or the Euclidean method.

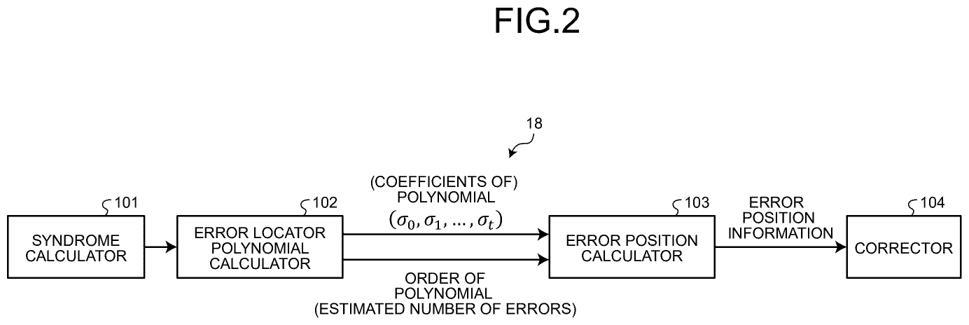

FIG. 2 is a block diagram illustrating a configuration example of the decoder 18 according to the present embodiment. As illustrated in FIG. 2, the decoder 18 includes a syndrome calculator 101, an error locator polynomial calculator 102, an error position calculator 103 serving as an arithmetic circuit, and a corrector 104.

The syndrome calculator 101 calculates a syndrome by using a received word (a read sequence) serving as data read from the nonvolatile memory 20. The syndrome calculator 101 may calculate the syndrome by using any conventionally used method. A plurality of syndromes is calculated depending on the number of corrections in some cases. In a case where values of all syndromes are zero, it can be determined that there are no errors in the received word, so that the decoder 18 can terminate the decoding processing without executing subsequent processing.

The error locator polynomial calculator 102 calculates the error locator polynomial according to the PGZ method, the BM method, the Euclidean method, or the like by using the syndrome. Some of the coefficients of the error locator polynomial are calculated by adding and multiplying syndromes.

Note that syndromes and coefficients o calculated by using the syndromes are elements of a Galois field. The Galois field is a set having 2^{m} (m is an integer of 1 or more) elements and defining four arithmetic operations characterized by a primitive polynomial of order m.

The error locator polynomial calculator 102 outputs coefficients of the calculated error locator polynomial and the order of the error locator polynomial. The order of the error locator polynomial corresponds to the estimated number of errors. It is assumed that coefficients of a t-th-order error locator polynomial are σᵢ (i is an integer satisfying 0≤i≤t). The t-th-order error locator polynomial σ(x) is expressed by, for example, Formula (1) described below. Note that the order of the error locator polynomial may not necessarily be output. In the error locator polynomial, a maximum value of the order of a term having a non-zero coefficient (σᵢ≠0) corresponds to the number of errors. Stated another way, argmax (σᵢ≠0) corresponds to the number of errors. Therefore, the error position calculator 103 observes coefficients of the error locator polynomial so that the number of errors can be estimated.

$$σ ( x ) = {σ}_{0} + {σ}_{1} x + {σ}_{2} {x}^{2} + … + {σ}_{t} {x}^{t} \qquad ( 1 )$$

The coefficient of is an element of the Galois field GF(2^{m}), as expressed by Formula (2) described below. α is a primitive element of the Galois field. A non-zero element of the Galois field can be expressed as a power of the primitive element α.

$${σ}_{i} ∈ GF ( {2}^{m} ) = \{ 0 , {α}^{0} , {α}^{1} , {α}^{2} , … , {α}^{{2}^{m} - 2} \} \qquad ( 2 )$$

The error position calculator 103 calculates an error position by using the error locator polynomial calculated by the error locator polynomial calculator 102. Processing for calculating the error position (search processing) may be implemented by using any method. In one example, the Chien search can be used. The Chien search is a method of sequentially substituting a value into the error locator polynomial, and searching for an error position on the basis of a value (a root of the error locator polynomial) at which an output value of the error locator polynomial becomes 0.

The corrector 104 executes error correction by inverting a bit in the error position calculated in the search processing (bit flipping).

The error position calculator 103 is implemented by, for example, a register, an adder, a multiplier, a selector, or another arithmetic unit. The syndrome calculator 101 and the error locator polynomial calculator 102 are also implemented by, for example, a register, an adder, a multiplier, a selector, or another arithmetic unit. The corrector 104 is implemented by, for example, an adder for adding a bit sequence reflecting error position information that has been output from the error position calculator 103 to a read sequence, but may be implemented by another arithmetic unit. Here, the bit sequence reflecting the error position information corresponds to, for example, a binary vector serving as an output of the polynomial evaluator described later. Furthermore, in a case where a root of the error locator polynomial is output as the error position information from the error position calculator 103, the corrector 104 may be implemented by an arithmetic unit that inverts a bit in the error position that corresponds to the root. The register is implemented by, for example, a logic circuit such as a flip-flop. The adder, the multiplier, the selector, or the other arithmetic unit is implemented by, for example, a logic circuit.

The Chien search is a method of sequentially substituting a value into the error locator polynomial, and searching for an error position, and the Chien search is configured to perform substitution processing in parallel in order to further reduce latency.

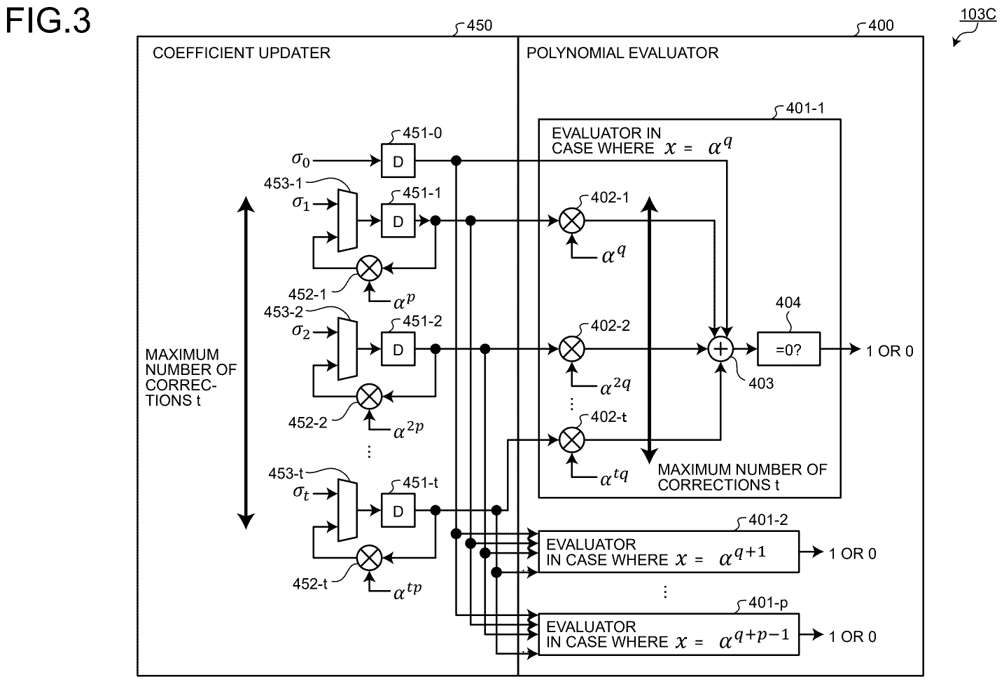

Here, a specific example of parallelized substitution processing will be described. FIG. 3 is a diagram illustrating a comparative example of a configuration of an error position calculator in which substitution processing has been parallelized (hereinafter, an error position calculator 103C). As illustrated in FIG. 3, the error position calculator 103C includes a coefficient updater 450 and a polynomial evaluator 400.

Hereinafter, it is assumed that the parallelism (a parallel number) of substitution processing is p. p can be interpreted as corresponding to the number of substitution values that are input in parallel from among substitution values that are input to an error locator polynomial. p is an integer that satisfies 1≤p<n. n is an integer of 2 or more that indicates a code length (bits) of an error correction code. The number of cycles r in which substitution processing is repeated is calculated in such a way that r=ceiling(n/p). ceiling(x) is a ceiling function for outputting the smallest integer greater than or equal to x.

The coefficient updater 450 includes t selectors 453-1 to 453-t, (t+1) registers 451-0 to 451-t, and t multipliers 452-1 to 452-t.

A selector 453-i (here, i is an integer that satisfies 1≤i≤t) outputs, to a register 451-i, either the coefficient σᵢ or an output of a multiplier 452-i.

The registers 451-0 to 451-t are configured by, for example, a storage element such as a flip-flop. In a case where coefficients of the error locator polynomial are elements of the Galois field GF(2^{m}), each of the elements is expressed as m bits. Accordingly, the respective registers 451-0 to 451-t are storage elements of 5 bits.

The register 451-0 stores the zeroth-order coefficient σ₀. The register 451-i stores a value that has been input from the selector 453-i during one cycle period, and outputs the value to the multiplier 452-i and the polynomial evaluator 400 in a post stage. For example, the registers 451-0 to 451-t respectively store the coefficients σ₀^{(j)} to σₜ^{(j)} in cycle j (j is an integer that satisfies 0≤j≤r−1). (j) is a sign indicating a value in cycle j.

The register 451-i (i is an integer that satisfies 1≤i≤t) excluding the register 451-0 may be implemented together with the selector 453-i and the multiplier 452-i.

Next, an operation of the coefficient updater 450 will be described. At the time of starting the operation, in all of the registers 451-0 to 451-t, a stored value is initialized to 0. Furthermore, all of the selectors 453-i are set to output, to the registers 451-i, a coefficient that has been input from the error locator polynomial calculator 102.

The coefficient σᵢ of the error locator polynomial that has been input from the error locator polynomial calculator 102 is stored in a corresponding register 451-i via the selector 453-i. The coefficient σ₀ does not have a corresponding selector, and therefore the coefficient σ₀ is directly stored in the register 451-0. Stated another way, each coefficient is set in such a way that σ₀⁽⁰⁾=σ₀ , σ₁⁽⁰⁾=σ₁, . . . , σₜ⁽⁰⁾=σₜ.

The substitution processing is repeatedly performed r times in order from cycle 0 (j=0). In cycle 0, all of the selectors 453-i are set to output, to a corresponding register 451-i, a value that has been input from the multiplier 452-i. The values σ₀⁽⁰⁾ to σₜ⁽⁰⁾ that have been stored in the registers 451-0 to 451-t are output to the polynomial evaluator 400. σ₁⁽⁰⁾ to σₜ⁽⁰⁾ excluding σ₀⁽⁰⁾ are output to respective corresponding multipliers of the multipliers 452-1 to 452-t. The multiplier 452-i multiplies an input value by α^{ip}. For example, in a case where parallelism p=5, the multipliers 452-1, 452-2, and 452-t respectively multiply an input value by α⁵, α¹⁰, and α^{t5}. A value after multiplication processing performed by the multiplier 452-i is input to the register 451-i via the selector 453-i. Stated another way, each of the coefficients is set in such a way that σ₀⁽¹⁾=σ₀, σ₁⁽¹⁾=σ₁⁽⁰⁾α⁵, σ₂⁽¹⁾=σ₂⁽⁰⁾α¹⁰, . . . , σₜ⁽¹⁾=σₜ⁽⁰⁾α^{t5}. Note that a value of σ₀^{(j)} is not updated from σ₀, which is an input value, in any cycle.

In cycle j that follows (j=1, 2, . . . , r−1), processing that is similar to processing in cycle 0 is performed to set each of the coefficients in such a way that σ₀^{(j+1)}=σ₀, σ₁^{(j+1)}=σ₁^{(j)}α⁵, σ₂^{(j+1)}=σ₂^{(j)}α¹⁰, . . . , σₜ^{(j+1)}=σₜ^{(j)}α^{t5}.

Next, a configuration of the polynomial evaluator 400 will be described. As illustrated in FIG. 3, the polynomial evaluator 400 includes p evaluators 401-1 to 401-p. The evaluators 401-1 to 401-p substitute the element α^{q+s} for an argument x of the error locator polynomial σ^{(j)}(x) that has been input from the coefficient updater 450, and perform evaluation to determine whether the value σ^{(j)}(α^{q+s}) of the error locator polynomial is 0. Note that σ^{(j)}(x) means an error locator polynomial that is output in cycle j. q is any integer of 0 to 2^{m}−2. For example, it can be established that q=0, but a value of q may be appropriately changed depending on implementation. Furthermore, s is an integer of 0 to p−1.

The evaluators 401-1 to 401-p have a similar function excluding the use of substitution values different from each other. A configuration of the evaluator 401-1 will be principally described below. Note that the evaluator 401-1 corresponds to a case where s=0. The other evaluators 401-2 to 401-p correspond to a configuration in which s (=0) of the evaluator 401-1 has been replaced with a corresponding value (1 to p−1).

As illustrated in FIG. 3, the evaluator 401-1 includes t multipliers 402-1 to 402-t, an adder 403, and a comparator circuit 404.

A multiplier 402-i (i is an integer that satisfies 1≤i≤t) multiplies a corresponding coefficient σᵢ^{(j)} by α^{i(q+s)}. The adder 403 calculates a value obtained by adding multiplication results of the t multipliers 402-1 to 402-t and the coefficient σ₀^{(j)} that has been input from the coefficient updater 450. The comparator circuit 404 outputs 1 in a case where an output of the adder 403 is 0, and outputs 0 in a case where the output is not 0.

Next, an operation of the polynomial evaluator 400 will be described. In each cycle j (j=0 to r−1), from among the coefficients σ₀^{(j)} to σₜ^{(j)} that have been input from the coefficient updater 450, the respective coefficients σ₁^{(j)} to σₜ^{(j)} excluding the coefficient σ₀ are multiplied by α^{i(q+s)} by the corresponding multipliers 402-1 to 402-t, and t multiplication results are output to the adder 403.

The adder 403 adds the t multiplication results and σ₀^{(j)}, and outputs an additional result to the comparator circuit 404. The comparator circuit 404 determines whether a value that has been input from the adder 403 is 0, and the comparator circuit 404 outputs 1 if the value is 0, and outputs 0 otherwise.

The polynomial evaluator 400 includes the p evaluators 401-1 to 401-p that perform such an operation. As described above, the p evaluators 401-1 to 401-p are different in α^{i(q+s)}. Specifically, in the evaluators 401-1 to 401-p, s takes respective different values of 0 to p−1. The polynomial evaluator 400 outputs a binary vector that has, as an element, a binary value (1 or 0) that has been output from each of the p evaluators 401-1 to 401-p, and has a length p.

Next, a specific example of evaluation of the error locator polynomial will be described. In the example described below, it is assumed that the order of the error locator polynomial is 4 (t=4), the parallelism p is 5, a code length n of an error correction code is 30, and the order m of a primitive polynomial is 5 (a Galois field is GF(2⁵)).

A primitive polynomial configuring GF(2⁵) is expressed by Formula (3) described below, and the root of the primitive polynomial is expressed as α. An error locator polynomial obtained by the error locator polynomial calculator 102 is expressed by Formula (4) described below.

$$p ( x ) = 1 + {x}^{2} + {x}^{5} \qquad ( 3 )$$

$$σ ( x ) = {σ}_{0} + {σ}_{1} x + {σ}_{2} {x}^{2} + {σ}_{3} {x}^{3} + {σ}_{4} {x}^{4} \qquad ( 4 )$$

In the error locator polynomial σ(x) of Formula (4), the order is 4, and therefore the error locator polynomial σ(x) has four roots. Accordingly, in error position calculation, from among elements 1, α, α², . . . , α²⁹ on GF(2⁵), four elements serving as the roots of the error locator polynomial σ(x) are searched for.

In a case where parallelism p=5, error locator polynomials into which five elements have been substituted are simultaneously evaluated in one cycle. Specifically, σ(x=α^{5j+q}), σ(x=α^{5j+q+1}), σ(x=α^{5j+q+2}), σ(x=α^{5j+q+3}), and σ(x=α^{5j+q+4}) are evaluated. In this example, j is an index in a cycle where a value of 0 to 5 is taken.

Next, the complexity of a circuit of the error position calculator 103C will be described. In the error position calculator 103C, circuits that contribute to complexity are a multiplier, an adder, and a register. In the example of FIG. 3, the coefficient updater 450 includes the t multipliers 452-1 to 452-t and the (t+1) registers 451-0 to 451-t. The polynomial evaluator 400 includes p×t multipliers (the t multipliers 402-1 to 402-t for each of the p evaluators 401-1 to 401-p) and p×t adders. This is because a single adder 403 corresponds to t adders of two inputs and one output.

In view of the above, the complexity of the error position calculator 103C is (p+1)×t multipliers, (t+1) registers, and p×t adders. In the case of substitution processing having the parallelism of 5 (p=5) performed on a fourth-order (t=4) error locator polynomial, the complexity is 24 multipliers, five registers, and 20 adders. Note that a single register corresponds to a storage element of five bits, and therefore five registers correspond to a storage element of 25 bits. In the case of the error position calculator 103C of an error locator polynomial on the Galois field GF (2^{m}), a single register corresponds to a storage element of m bits.

As a method of reducing the complexity of a circuit for error position calculation, a method of contracting a polynomial by using affine decomposition has been proposed (for example, S. V. Fedorenko, et al., “Finding roots of polynomials over finite fields”, IEEE Transactions on Communications (Volume: 50, Issue: 11, November 2002)).

For example, if affine decomposition is applied to a t-th-order error locator polynomial σ(x), the t-th-order error locator polynomial σ(x) can be transformed as described in Formula (5) described below. k is an integer that takes a value of 0 to K. K is the smallest integer greater than or equal to (t−4)/5 (ceiling((t−4)/5).

$$σ ( x ) = {σ}_{3} {x}^{3} + {\sum }_{k = 0}^{⌈ \frac{t - 4}{5} ⌉} {x}^{5 k} ( {σ}_{5 k} + {L}_{k} ( x ) ) \qquad ( 5 )$$

In Formula (5), Lₖ(x) is expressed by Formula (6) described below. Furthermore, Formula (6) can be transformed as described in Formula (7) described below. Note that in Formula (7), Q is an m×m binary matrix that corresponds to square calculation, and it is satisfied that Qx=x².

$${L}_{k} ( x ) = {\sum }_{h = 0}^{3} {σ}_{5 k + {2}^{h}} {x}^{{2}^{h}} \qquad ( 6 )$$

$$\begin{matrix}{L}_{k} ( x ) = {σ}_{5 k + 1} x + {σ}_{5 k + 2} {x}^{2} + {σ}_{5 k + 4} {x}^{4} + {σ}_{5 k + 8} {x}^{8} \\ = {σ}_{5 k + 1} x + {σ}_{5 k + 2} Qx + {σ}_{5 k + 4} {Q}^{2} x + {σ}_{5 k + 8} {Q}^{3} x \\ = ( {σ}_{5 k + 1} + {σ}_{5 k + 2} Q + {σ}_{5 k + 4} {Q}^{2} + {σ}_{5 k + 8} {Q}^{3} ) x \\ = {Δ}_{k} x\end{matrix} \qquad ( 7 )$$

In Formula (5), a second term of a right-hand side corresponds to one or more affine polynomials obtained by decomposing an error locator polynomial. Each of the affine polynomials includes Lₖ(x), which is a linearized polynomial, and σ₅ₖ, which is a constant term. As expressed by Formula (7), the linearized polynomial Lₖ(x) can be transformed into a form of multiplying x by Δₖ, which is a binary matrix (a binary matrix). Hereinafter, a matrix Δₖ is referred to as a linearized polynomial matrix.

In a case where t=4, k only takes a value of 0, and an error locator polynomial to which affine decomposition has been applied is transformed as described in Formula (8) described below. In Formula (8), L₀(x) is expressed by Formula (9) described below.

$$σ ( x ) = {σ}_{3} {x}^{3} + {σ}_{0} + {L}_{0} ( x ) \qquad ( 8 )$$

$${L}_{0} ( x ) = {σ}_{1} x + {σ}_{2} {x}^{2} + {σ}_{4} {x}^{4} \qquad ( 9 )$$

As described above, L₀(x) in Formula (9) is a linearized polynomial, and therefore L₀(x) can be calculated by multiplying x by the linearized polynomial matrix Δ₀. Formula (10) described below indicates an error locator polynomial that is expressed in a form using the linearized polynomial matrix Δ₀.

$$σ ( x ) = {σ}_{3} {x}^{3} + {σ}_{0} + {Δ}_{0} ( x ) \qquad ( 10 )$$

Note that Δ₀ is a polynomial on GF(2⁵), and therefore Δ₀ is a 5×5 binary matrix. In the case of a general polynomial on GF(2^{m}), Δ₀ is an m×m binary matrix.

In view of the above, the complexity of the error locator polynomial σ(x) can be evaluated by using the error locator polynomial σ(x) of Formula (10). It is apparent that Formula (10) has a smaller number of multiplications and additions than Formula (4).

Conventionally, (for example, S. V. Fedorenko, et al., “Finding roots of polynomials over finite fields”, IEEE Transactions on Communications (Volume: 50, Issue: 11, November 2002)), it has not been considered that affine decomposition is applied to a configuration in which error locator polynomials are evaluated in parallel, and a method of applying affine decomposition to an error position calculator that parallelizes and calculating error polynomials, as described as the error position calculator 103C (hereinafter referred to as a parallel error position calculator) has not been clarified.

In the parallel error position calculator, an evaluator that performs substitution processing on a polynomial is a circuit that substitutes the fixed value α^{q+s}, and the coefficients σᵢ^{(j)} of the polynomial are updated by the coefficient updater in each cycle. In a case where affine decomposition is applied to the parallel error position calculator, as described above, the linearized polynomial L₀(x) also needs to be updated in each cycle.

A conceivable example of a configuration in which affine decomposition is applied to the parallel error position calculator is a configuration in which a linearized polynomial is updated in the evaluator. In such a configuration, each of a plurality of evaluators needs to individually perform an arithmetic operation to update the linearized polynomial, and therefore the size of a circuit (complexity) fails to be efficiently reduced.

In view of this, in the present embodiment, a configuration of a parallel error position calculator to which affine decomposition has been applied and that can further reduce complexity will be described.

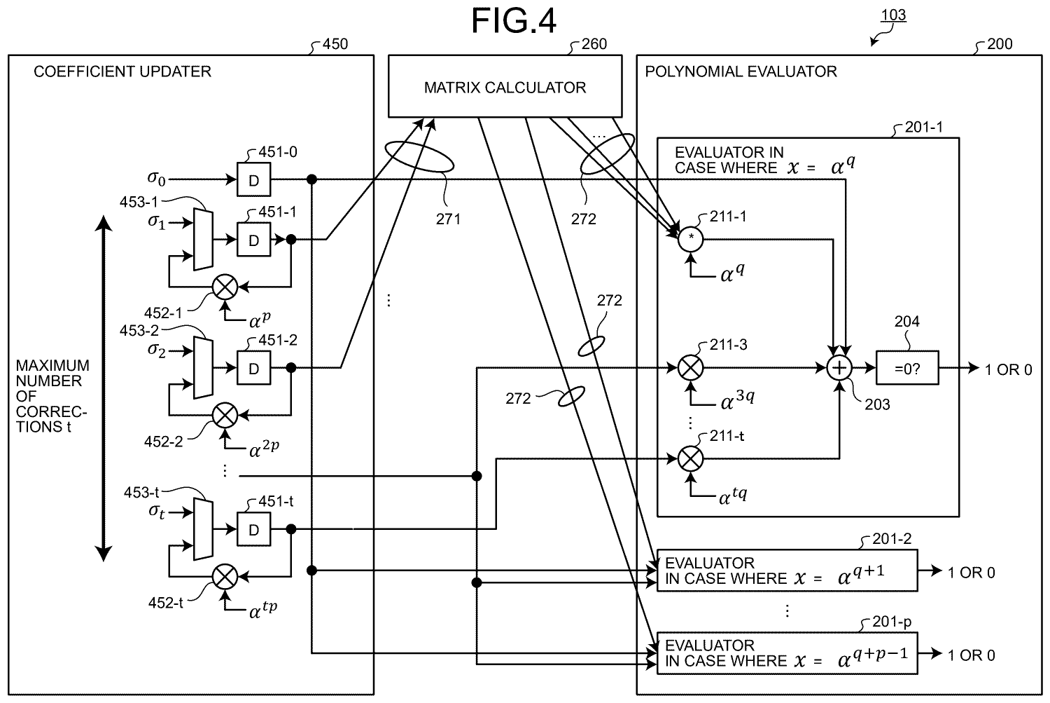

FIG. 4 is a diagram illustrating a configuration example of the error position calculator 103 according to the embodiment. The error position calculator 103 of FIG. 4 is different from the error position calculator 103C of FIG. 3, and corresponds to the error position calculator to which affine decomposition has been applied.

As illustrated in FIG. 4, the error position calculator 103 includes a coefficient updater 450, a matrix calculator 260, and a polynomial evaluator 200. The coefficient updater 450 has a configuration that is similar to a configuration of the coefficient updater 450 included in the error position calculator 103C of FIG. 3, and therefore the same reference sign is given, and description is omitted.

The matrix calculator 260 calculates a linearized polynomial matrix, which is a binary matrix that corresponds to a linearized polynomial. For example, the matrix calculator 260 calculates the linearized polynomial matrix Δₖ^{(j)} in each cycle j. Details of the matrix calculator 260 will be described with reference to the drawings that follow, by using, as examples, cases where t=4 and t=7.

As described in Formula (7) described above, in calculating the linearized polynomial matrix, the coefficients σᵢ^{(j)} in a case where i=5k+1, 5k+2, 5k+4, and 5k+8 are used. Therefore, the coefficients σᵢ^{(j)} that correspond to the case where i=5k+1, 5k+2, 5k+4, and 5k+8 are input from the coefficient updater 450 to the matrix calculator 260 (an input 271 of FIG. 4). Note that the coefficient σᵢ^{(j)} that corresponds to another i is input from the coefficient updater 450 to the polynomial evaluator 200. The linearized polynomial matrix Δₖ^{(j)} (k=0 to K) is calculated by the matrix calculator 260 in each cycle j, and is output to the polynomial evaluator 200 (an output 272 of FIG. 4). From among a plurality of coefficients of an error locator polynomial, a coefficient to be used to calculate a matrix (the coefficients σᵢ^{(j)} that correspond to the case where i=5k+1, 5k+2, 5k+4, and 5k+8) is hereinafter referred to as a target coefficient. Furthermore, from among the plurality of coefficients of the error locator polynomial, a coefficient other than the targe coefficient is hereinafter referred to as a non-target coefficient.

The polynomial evaluator 200 evaluates, in parallel, values of error locator polynomials into which a substitution value has been substituted. The polynomial evaluator 200 includes p evaluators 201-1 to 201-p.

The evaluators 201-1 to 201-p substitute the element α^{q+s} for an argument x of the error locator polynomial σ^{(j)}(x) that has been input from the coefficient updater 450, and perform evaluation to determine whether the value σ^{(j)}(α^{q+s}) of the error locator polynomial is 0. In the present embodiment, the evaluators 201-1 to 201-p include a circuit that is configured to use a linearized polynomial matrix that has been output from the matrix calculator 260.

Description will be provided by using an example of the evaluator 201-1 that corresponds to a case where s=0. The other evaluators 201-2 to 201-p correspond to a circuit in which s (=0) of the evaluator 201-1 has been replaced with a corresponding value (1 to p−1).

As illustrated in FIG. 4, the evaluator 201-1 includes multipliers 211-1, 211-3, . . . , 211-t, an adder 203, and a comparator circuit 204.

In the present embodiment, multiplication of the m×m binary matrix (the linearized polynomial matrix) that has been output from the matrix calculator 260 by αⁱ of binary vector expression (hereinafter referred to as matrix multiplication) is performed in some cases. In FIG. 4 and the drawings that follow, matrix multiplication is illustrated as the sign “*” surrounded by a circle. The multiplier 211-1 corresponds to a circuit that calculates a multiplication result (a first multiplication result) obtained by matrix-multiplying the linearized polynomial matrix by α^{q} (corresponding to a first multiplication value based on a substitution value). Whether matrix multiplication is performed depends on the order t of the error locator polynomial. Accordingly, the multiplier 211-t of FIG. 4 performs matrix multiplication in some cases. Furthermore, the coefficient σₜ^{(j)} stored in the register 451-t is output as the target coefficient to the matrix calculator 260 in some cases.

The multiplier 211-3 corresponds to a circuit that does not perform matrix multiplication, but performs multiplication relating to one or more evaluation terms that are included in an affine polynomial, and are different from the linearized polynomial. For example, the multiplier 211-3 calculates a multiplication result (a second multiplication result) obtained by multiplying α^{3q} (corresponding to a second multiplication value based on a substitution value) by the coefficient σ₃^{(j)} that corresponds to the evaluation term that is different from the linearized polynomial. As described above, any of the non-target coefficients corresponds to the evaluation term.

The evaluators 201-1 to 201-p according to the present embodiment do not need to include t multipliers in contrast to, for example, the evaluators 401-1 to 401-p of FIG. 3, and include a certain number of multipliers that corresponds to some of t coefficients σ.

The adder 203 calculates a value obtained by adding the multiplication results of the multipliers 211-1, 211-3, . . . , 211-t and the coefficient σ₀^{(j)} that has been input from the coefficient updater 450. The comparator circuit 204 outputs 1 in a case where an output of the adder 203 is 0, and outputs 0 in a case where the output is not 0.

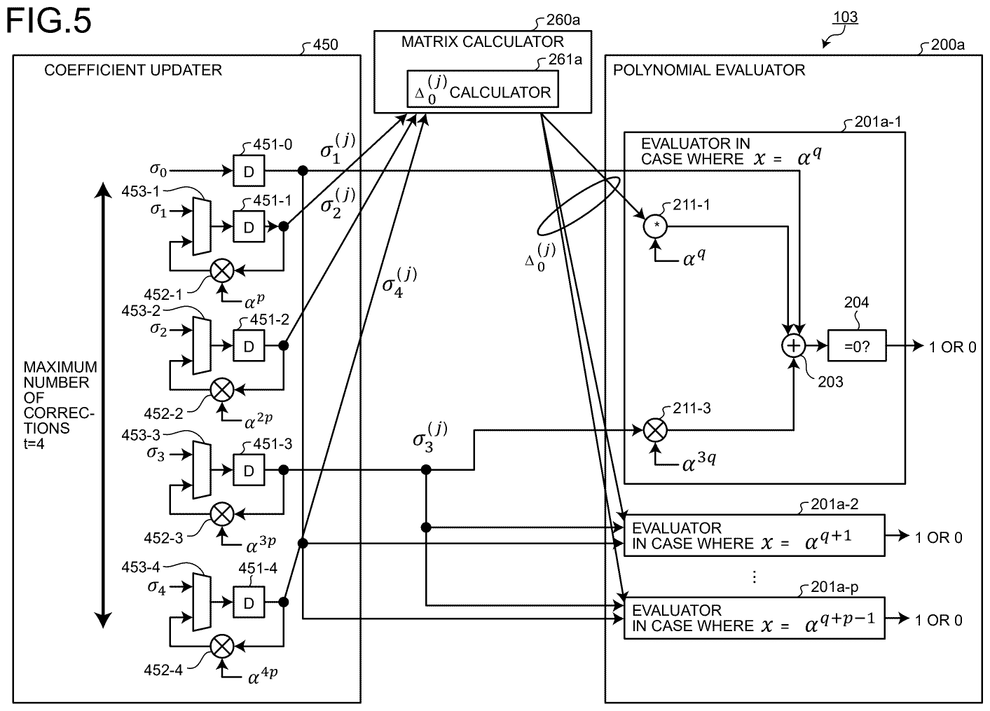

Next, a configuration example of the error position calculator 103 in a case where t=4, p=5, and m=5 will be described. As described above, in a case where t=4, the error locator polynomial is expressed by Formula (8) by applying affine decomposition. FIG. 5 is a diagram illustrating a configuration example of the error position calculator 103 for the error locator polynomial of Formula (8).

As illustrated in FIG. 5, the error position calculator 103 includes a coefficient updater 450, a matrix calculator 260a, and a polynomial evaluator 200a. The coefficient updater 450 is similar to the coefficient updaters 450 of FIGS. 3 and 4 excluding embodying t as 4.

The matrix calculator 260a includes a Δ₀^{(j)} calculator 261a. The Δ₀^{(j)} calculator 261a is a circuit that calculates the linearized polynomial matrix Δ₀^{(j)}. As described in Formula (9), in a case where t=4, the coefficients σ₁^{(j)}, σ₂^{(j)}, and σ₄^{(j)} in a case where i=1, 2, and 4 are used as the target coefficients. Accordingly, the coefficients σ₁^{(j)}, σ₂^{(j)}, and σ₄^{(j)} are input from the coefficient updater 450 to the matrix calculator 260a. Furthermore, the matrix calculator 260a (the Δ₀^{(j)} calculator 261a) calculates Δ₀^{(j)}, and outputs Δ₀^{(j)} to the polynomial evaluator 200a. Details of the Δ₀^{(j)} calculator 261a will be described later.

The polynomial evaluator 200a includes p evaluators 201a-1 to 201a-p. Description will be provided by using the example of the evaluator 201a-1. The evaluator 201a-1 includes multipliers 211-1 and 211-3, the adder 203, and the comparator circuit 204.

The multiplier 211-1 performs multiplication (matrix multiplication) of the linearized polynomial matrix Δ₀^{(j)} by α^{q}, and outputs a multiplication result. The multiplier 211-3 performs multiplication (multiplication on the Galois field GF(2⁵)) of the coefficient σ₃^{(j)} that has been input from the coefficient updater 450 by α^{3q}, and outputs a multiplication result. The adder 203 calculates a value obtained by adding the multiplication result of the multiplier 211-1, the multiplication result of the multiplier 211-3, and the coefficient σ₀^{(j)}.

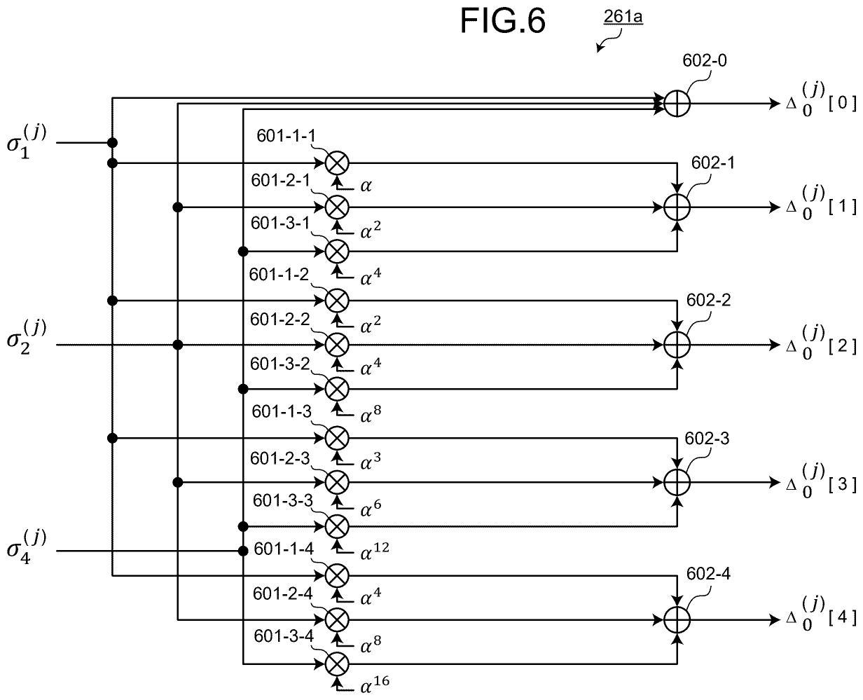

FIG. 6 is a diagram illustrating a configuration example of the Δ₀^{(j)} calculator 261a. Because m=5, the calculated Δ₀^{(j)} includes five elements, Δ₀^{(j)}[0], Δ₀^{(j)}[1], Δ₀^{(j)}[2], Δ₀^{(j)}[3], and Δ₀^{(j)}[4]. Each of the five elements corresponds to a vector of five rows and one column. The linearized polynomial matrix Δ₀^{(j)} corresponds to a matrix of five rows and five columns in which the five elements have been coupled in a column direction.

The Δ₀^{(j)} calculator 261a includes adders 602-0 and 602-g and multipliers 601-1-g, 601-2-g, and 601-3-g. Note that g is an integer that takes a value of 1 to 4 (corresponding to m−1).

The adder 602-0 adds the coefficients σ₁^{(j)}, σ₂^{(j)}, and σ₄^{(j)}, and outputs an additional result as Δ₀^{(j)}[0].

The multiplier 601-1-g multiplies the coefficient σ₁^{(j)} by the multiplication value α^{1×g} (a first multiplier). The multiplier 601-2-g multiplies the coefficient σ₂^{(j)} by the multiplication value α^{2×g}. The multiplier 601-3-g multiplies the coefficient σ₄^{(j)} by the multiplication value α^{4×g}. The multiplication value α^{1×g}, the multiplication value α^{2×g}, and the multiplication value α^{4×g} correspond to predetermined multiplication values (third multiplication values) that are different according to a plurality of target coefficients.

The adder 602-g adds respective multiplication results (third multiplication results) of the multiplier 601-1-g, the multiplier 601-2-g, and the multiplier 601-3-g, and outputs an addition result as Δ₀^{(j)}[g].

Grounds that the matrix Δ₀^{(j)} can be calculated by using the Δ₀^{(j)} calculator 261a of FIG. 6 will be described.

Formula (4) described above that expresses a fourth-order error locator polynomial σ(x) can be transformed as described in Formula (11) described below.

$$\begin{matrix}σ ( x ) = ( \begin{matrix}1 & x & {x}^{2} & {x}^{3} & {x}^{4}\end{matrix} ) ( \begin{matrix}{σ}_{0} \\ {σ}_{1} \\ {σ}_{2} \\ {σ}_{3} \\ {σ}_{4}\end{matrix} ) \\ = {x}^{3} {σ}_{3} + \{ {σ}_{0} + ( \begin{matrix}x & {x}^{2} & {x}^{4}\end{matrix} ) ( \begin{matrix}{σ}_{1} \\ {σ}_{2} \\ {σ}_{4}\end{matrix} ) \}\end{matrix} \qquad ( 11 )$$

Here, if x is decomposed in the basis {bᵢ} (i is an integer of 0 to m−1), x can be expressed by Formula (12) described below.

$$x = {\sum }_{i = 0}^{m - 1} {x}_{i} {b}_{i} \qquad ( 12 )$$

If Formula (12) is used, the matrix (x x² x⁴) included in Formula (11) can be transformed as described in Formula (13) described below. Furthermore, if Formula (13) is used, Formula (11) can be expressed by Formula (14) described below.

$$\begin{matrix}( \begin{matrix}x & {x}^{2} & {x}^{4}\end{matrix} ) = \begin{matrix}( {\sum }_{i = 0}^{m - 1} {x}_{i} {b}_{i} & {( {\sum }_{i = 0}^{m - 1} {x}_{i} {b}_{i} )}^{2} & {( {\sum }_{i = 0}^{m - 1} {x}_{i} {b}_{i} )}^{4} )\end{matrix} \\ = \begin{matrix}( {\sum }_{i = 0}^{m - 1} {x}_{i} {b}_{i} & {\sum }_{i = 0}^{m - 1} {x}_{i} {b}_{i}^{2} & {\sum }_{i = 0}^{m - 1} {x}_{i} {b}_{i}^{4} )\end{matrix} \\ = {\sum }_{i = 0}^{m - 1} {x}_{i} \begin{matrix}( {b}_{i} & {( {b}_{i} )}^{2} & {( {b}_{i} )}^{4} )\end{matrix}\end{matrix} \qquad ( 13 )$$

$$\begin{matrix}σ ( x ) = {x}^{3} {σ}_{3} + \{ {σ}_{0} + {\sum }_{i = 0}^{m - 1} {x}_{i} \begin{matrix}( {b}_{i} & {( {b}_{i} )}^{2} & {( {b}_{i} )}^{4} ) ( \begin{matrix}{σ}_{1} \\ {σ}_{2} \\ {σ}_{4}\end{matrix} ) \}\end{matrix} \\ = {x}^{3} {σ}_{3} + \{ {σ}_{0} + {\sum }_{i = 0}^{m - 1} {x}_{i} {Δ}_{0} [ i ] \}\end{matrix} \qquad ( 14 )$$

Δ₀[i] in Formula (14) corresponds to column i of the linearized polynomial matrix Δ₀, and is expressed by Formula (15) described below.

$${Δ}_{0} [ i ] = \begin{matrix}( {b}_{i} & {( {b}_{i} )}^{2} & {( {b}_{i} )}^{4} ) ( \begin{matrix}{σ}_{1} \\ {σ}_{2} \\ {σ}_{4}\end{matrix} )\end{matrix} \qquad ( 15 )$$

The Δ₀^{(j)} calculator 261a of FIG. 6 corresponds to a circuit that calculates the linearized polynomial matrix Δ₀ by using αⁱ as the basis {bᵢ}, as described in Formula (15).

Next, matrix multiplication in the evaluators 201a-1 to 201a-p will be described. As described above, in the example of FIG. 5, the multiplier 211-1 performs multiplication (matrix multiplication) of the linearized polynomial matrix Δ₀^{(j)} by α^{q}. This matrix multiplication corresponds to, for example, multiplication in a second term of a right-hand side in a second row in Formula (14), and is expressed by Formula (16) described below. (α^{q})ᵢ indicates an i-th bit of α^{q}.

$${Δ}_{0}^{( j )} {α}^{q} = {\sum }_{i = 0}^{m - 1} \begin{matrix}{( {α}^{q} )}_{i} & {Δ}_{0}^{( j )} [ i ]\end{matrix} \qquad ( 16 )$$

Stated another way, the matrix multiplication of Formula (16) corresponds to a result of addition on GF(2) of Δ₀^{(j)}[i] that corresponds to an index i that takes 1 when α^{q} is expressed as a vector. α^{q} takes a fixed value for each of the evaluators 201a-1 to 201a-p, and therefore an index that specifies a column to be subjected to addition does not change for each cycle. Accordingly, the Δ₀^{(j)} calculator can be configured as a circuit that multiplies Δ₀^{(j)}[i] that corresponds to an index that is uniquely determined from α^{q}, for each of the evaluators 201a-1 to 201a-p.

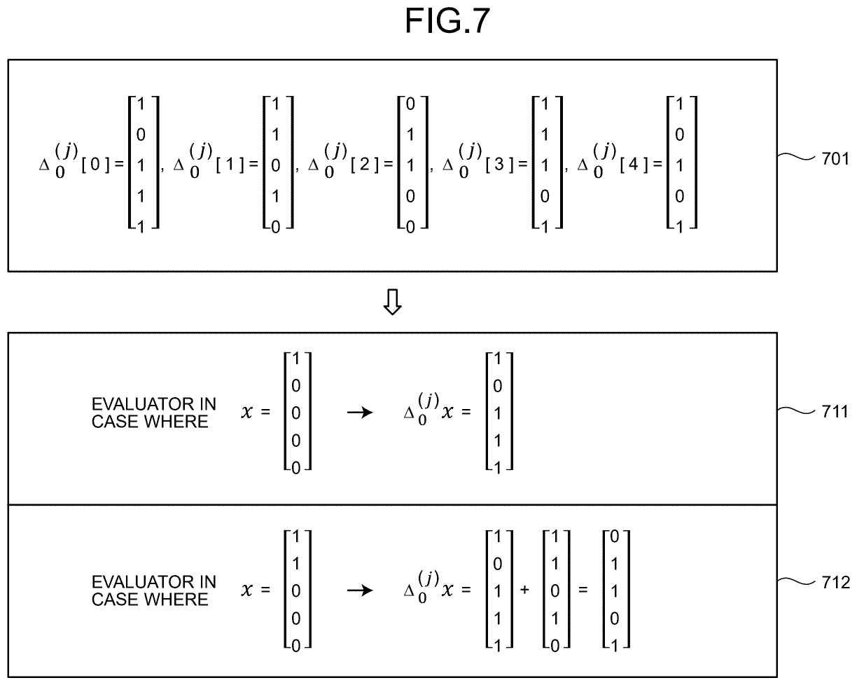

FIG. 7 is a diagram for explaining an example of matrix multiplication in the evaluators 201a-1 to 201a-p. It is assumed that each column of the linearized polynomial matrix Δ₀ takes a value as illustrated as Formula 701. Formulae 711 and 712 express a value x (the vector expression of a fixed value α^{q}) that is specified according to an evaluator, and a formula of matrix multiplication in the evaluator.

Next, a configuration example of the error position calculator 103 in a case where t=7, p=5, and m=5 will be described. In a case where t=7, an error locator polynomial is expressed by Formula (17) described below. Furthermore, an error locator polynomial in which affine decomposition has been applied to Formula (17) is expressed by Formula (18) described below.

$$σ ( x ) = {σ}_{0} + {σ}_{1} x + {σ}_{2} {x}^{2} + {σ}_{3} {x}^{3} + {σ}_{4} {x}^{4} + {σ}_{5} {x}^{5} + {σ}_{6} {x}^{6} + {σ}_{7} {x}^{7} \qquad ( 17 )$$

$$σ ( x ) = {σ}_{0} + {σ}_{3} {x}^{3} + {Δ}_{0} x + ( {σ}_{5} + {Δ}_{1} x ) {x}^{5} \qquad ( 18 )$$

Δ₀x and Δ₁x in Formula (18) are respectively expressed by Formula (19) and Formula (20) described below.

$${Δ}_{0} x = {σ}_{1} x + {σ}_{2} {x}^{2} + {σ}_{4} {x}^{4} \qquad ( 19 )$$

$${Δ}_{1} x = {σ}_{6} x + {σ}_{7} {x}^{2} \qquad ( 20 )$$

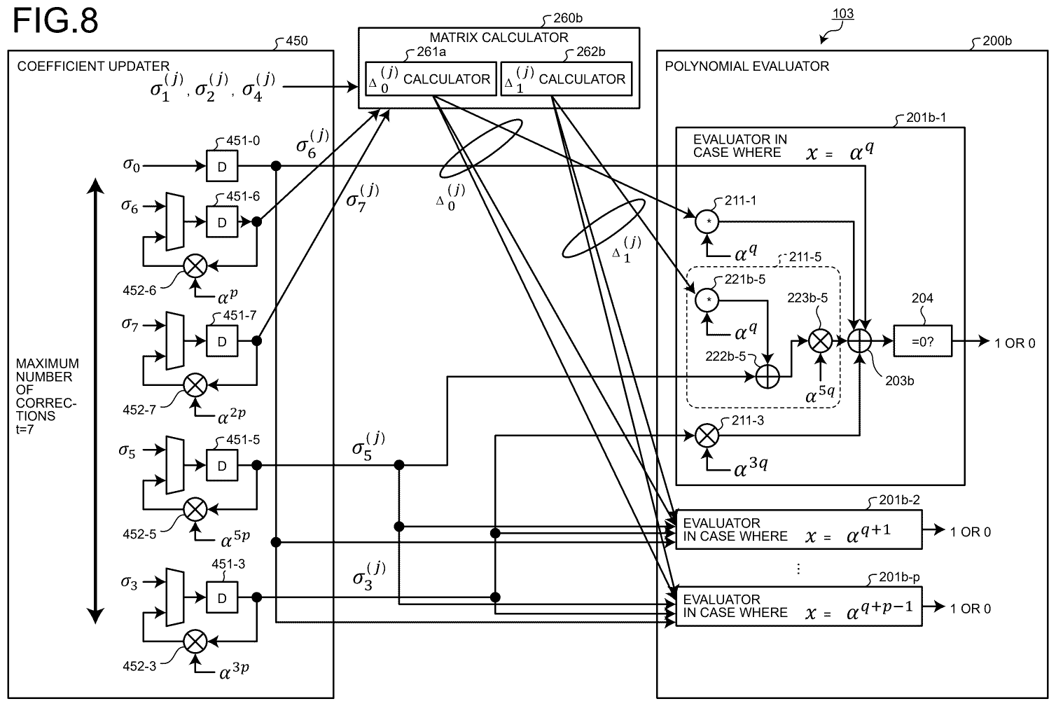

FIG. 8 is a diagram illustrating a configuration example of the error position calculator 103 for the error locator polynomial of Formula (18). As illustrated in FIG. 8, the error position calculator 103 includes a coefficient updater 450, a matrix calculator 260b, and a polynomial evaluator 200b. The coefficient updater 450 is similar to the coefficient updaters 450 of FIGS. 3 and 4 excluding embodying t as 7. Note that in the coefficient updater 450 of FIG. 8, functions relating to the coefficients σ₁(^{j}), σ₂(^{j}), and σ₄(^{j}) are illustrated in a simplified manner.

The matrix calculator 260b includes a Δ₀^{(j)} calculator 261a and a Δ₁^{(j)} calculator 262b. The Δ₀^{(j)} calculator 261a has a function that is similar to the function in FIG. 5 in a case where t=4, and therefore the same reference sign is given, and description is omitted.

In a case where t=7, k takes a value of 0 or 1. Therefore, the matrix calculator 260b calculates Δ₀^{(j)} and Δ₁^{(j)} as the linearized polynomial matrix Δₖ^{(j)}. The Δ₁^{(j)} calculator 262b corresponds to a circuit that calculates the linearized polynomial matrix Δ₁^{(j)}.

As described in Formula (20), in calculating Δ₁^{(j)}, the coefficients σ₆^{(j)} and σ₇^{(j)} in a case where i=6 and 7 are used as the target coefficients. Accordingly, the coefficients σ₆^{(j)} and σ₇^{(j)} in addition to the coefficients σ₁^{(j)}, σ₂^{(j)}, and σ₄^{(j)} are input from the coefficient updater 450 to the matrix calculator 260a. Furthermore, the matrix calculator 260b calculates Δ₀^{(j)} and Δ₁^{(j)}, and outputs Δ₀^{(j)} and Δ₁^{(j)} to the polynomial evaluator 200b. Details of the Δ₁^{(j)} calculator 262b will be described later.

The polynomial evaluator 200b includes p evaluators 201b-1 to 201b-p. Description will be provided by using the example of the evaluator 201b-1. The evaluator 201b-1 includes multipliers 211-1, 211-3, and 211-5, an adder 203b, and the comparator circuit 204.

Functions of the multipliers 211-1 and 211-3 are similar to functions in FIG. 5. The evaluator 201b-1 further includes a multiplier 211-5 that performs multiplication using the linearized polynomial matrix Δ₁^{(j)}. The multiplier 211-5 corresponds to a circuit that performs the calculation of a fourth term of a right-hand side in Formula (18). The multiplier 211-5 includes a multiplier 221b-5, an adder 222b-5, and a multiplier 223b-5.

The multiplier 221b-5 performs multiplication (matrix multiplication) of the linearized polynomial matrix Δ₁^{(j)} by α^{q} (corresponding to the first multiplication value based on the substitution value), and outputs a multiplication result. The adder 222b-5 adds the coefficient σ₅^{(j)} that has been input from the coefficient updater 450 and a multiplication result of the multiplier 211-5. The multiplier 223b-5 performs multiplication (multiplication on the Galois field GF(2^{m})) of an addition result of the adder 222b-5 and α^{5q} (corresponding to the first multiplication value based on the substitution value). A multiplication result of the multiplier 223b-5 is output as a multiplication result (the first multiplication result) of the multiplier 211-5.

The adder 203b calculates a value obtained by adding a multiplication result of the multiplier 211-1, a multiplication result of the multiplier 211-3, the multiplication result of the multiplier 211-5, and the coefficient σ₀^{(j)}.

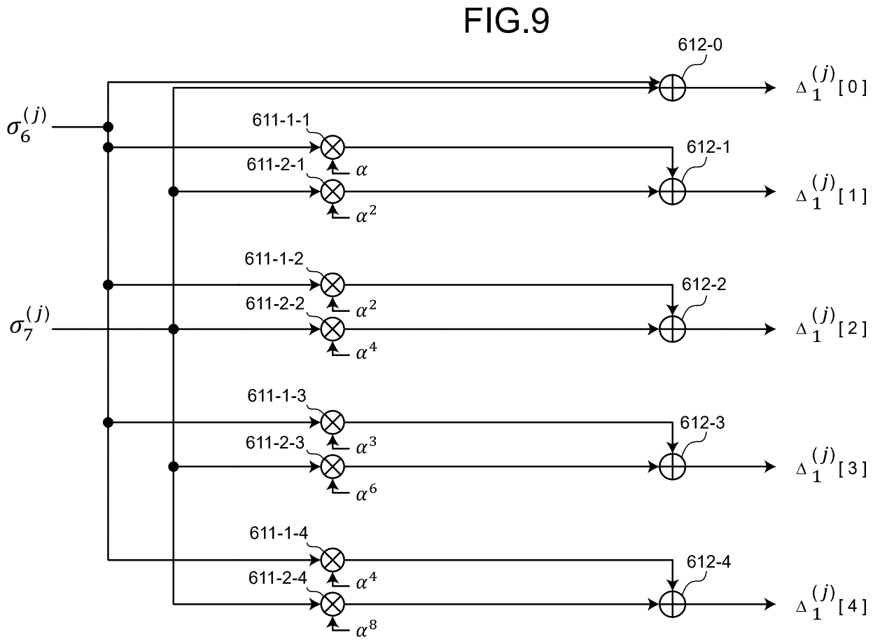

FIG. 9 is a diagram illustrating a configuration example of the Δ₁^{(j)} calculator 262b. Because m=5, the calculated Δ₁^{(j)} includes five elements, Δ₁^{(j)}[0], Δ₁^{(j)}[1], Δ₁^{(j)}[2], Δ₁^{(j)}[3], and Δ₁^{(j)}[4]. Each of the five elements corresponds to a vector of five rows and one column. The linearized polynomial matrix Δ₁^{(j)} corresponds to a matrix of five rows and five columns in which the five elements have been coupled in the column direction.

The Δ₁^{(j)} calculator 262b includes adders 612-0 and 612-g and multipliers 611-1-g and 611-2-g. Note that g is an integer that takes a value of 1 to 4 (corresponding to m−1).

The adder 612-0 adds the coefficients σ₆^{(j)} and σ₇^{(j)}, and outputs an addition result as Δ₁^{(j)}[0].

The multiplier 611-1-g multiplies the coefficient σ₆^{(j)} by the multiplication value α^{1×g}. The multiplier 611-2-g multiplies the coefficient σ₇^{(j)} by the multiplication value α^{2×g}. The multiplication value α^{1×g} and the multiplication value α^{2×g} correspond to predetermined multiplication values (the third multiplication values) that are different according to a plurality of coefficients.

The adder 612-g adds respective multiplication results of the multiplier 611-1-g and the multiplier 611-2-g. In the example of FIG. 9, an addition result of the adder 612-g is output as Δ₁^{(j)}[g].

Grounds that the matrix Δ₁^{(j)} can be calculated by using the Δ₁^{(j)} calculator 262b of FIG. 9 will be described.

Formula (17) described above that expresses a seventh-order error locator polynomial σ(x) can be transformed as described in Formula (21) described below.

$$\begin{matrix}σ ( x ) = ( \begin{matrix}1 & x & {x}^{2} & {x}^{3} & {x}^{4} & {x}^{5} & {x}^{6} & {x}^{7}\end{matrix} ) ( \begin{matrix}{σ}_{0} \\ {σ}_{1} \\ {σ}_{2} \\ {σ}_{3} \\ {σ}_{4} \\ {σ}_{5} \\ {σ}_{6} \\ {σ}_{7}\end{matrix} ) \\ = {x}^{3} {σ}_{3} + \{ {σ}_{0} + ( \begin{matrix}x & {x}^{2} & {x}^{4}\end{matrix} ) ( \begin{matrix}{σ}_{1} \\ {σ}_{2} \\ {σ}_{4}\end{matrix} ) \} + {x}^{5} \{ {σ}_{5} + ( \begin{matrix}x & {x}^{2}\end{matrix} ) ( \begin{matrix}{σ}_{6} \\ {σ}_{7}\end{matrix} ) \}\end{matrix} \qquad ( 21 )$$

If Formula (12) described above is used, the matrix (x x²) included in Formula (21) can be transformed as described in Formula (22) described below. Furthermore, if Formula (13) and Formula (22) that have been described above are used, Formula (21) can be expressed by Formula (23) described below.

$$\begin{matrix}( \begin{matrix}x & {x}^{2}\end{matrix} ) = \begin{matrix}( {\sum }_{i = 0}^{m - 1} {x}_{i} {b}_{i} & {( {\sum }_{i = 0}^{m - 1} {x}_{i} {b}_{i} )}^{2} )\end{matrix} \\ = \begin{matrix}( {\sum }_{i = 0}^{m - 1} {x}_{i} {b}_{i} & {\sum }_{i = 0}^{m - 1} {x}_{i} {b}_{i}^{2} )\end{matrix} \\ = {\sum }_{i = 0}^{m - 1} {x}_{i} \begin{matrix}( {b}_{i} & {( {b}_{i} )}^{2} )\end{matrix}\end{matrix} \qquad ( 22 )$$

$$\begin{matrix}σ ( x ) = {x}^{3} {σ}_{3} + \{ {σ}_{0} + {\sum }_{i = 0}^{m - 1} {x}_{i} \begin{matrix}( {b}_{i} & {( {b}_{i} )}^{2} & {( {b}_{i} )}^{4} ) ( \begin{matrix}{σ}_{1} \\ {σ}_{2} \\ {σ}_{4}\end{matrix} ) \}\end{matrix} \\ + {x}^{5} \{ {σ}_{5} + {\sum }_{i = 0}^{m - 1} {x}_{i} \begin{matrix}( {b}_{i} & {( {b}_{i} )}^{2} ) ( \begin{matrix}{σ}_{6} \\ {σ}_{7}\end{matrix} ) \}\end{matrix} \\ = {x}^{3} {σ}_{3} + \{ {σ}_{0} + {\sum }_{i = 0}^{m - 1} {x}_{i} {Δ}_{0} [ i ] \} + {x}^{5} \{ {σ}_{5} + {\sum }_{i = 0}^{m - 1} {x}_{i} {Δ}_{1} [ i ] \}\end{matrix} \qquad ( 23 )$$

Δ₁[i] in Formula (23) corresponds to column i of the linearized polynomial matrix Δ₁, and is expressed by Formula (24) described below.

$${Δ}_{1} [ i ] = \begin{matrix}( {b}_{i} & {( {b}_{i} )}^{2} ) ( \begin{matrix}{σ}_{6} \\ {σ}_{7}\end{matrix} )\end{matrix} \qquad ( 24 )$$

The Δ₁^{(j)} calculator 262b of FIG. 9 corresponds to a circuit that calculates the linearized polynomial matrix Δ₁ by using αⁱ as the basis {bᵢ}, as described in Formula (24).

So far, an example in a case where t=4 or t=7, that is, a case where k is 0 or k is 0 and 1, has been principally described. t is not limited to 4 or 7, and t may have any value. If t has a greater value, k can take a value of 2 or more. In such a case, a Δₖ^{(j)} calculator that calculates Δₖ^{(j)} (k is an integer of 2 or more) can be configured similarly to the Δ₀^{(j)} calculator 261a and the Δ₁^{(j)} calculator 262b. Stated another way, the matrix calculator 260 can include kΔₖ^{(j)} calculators.

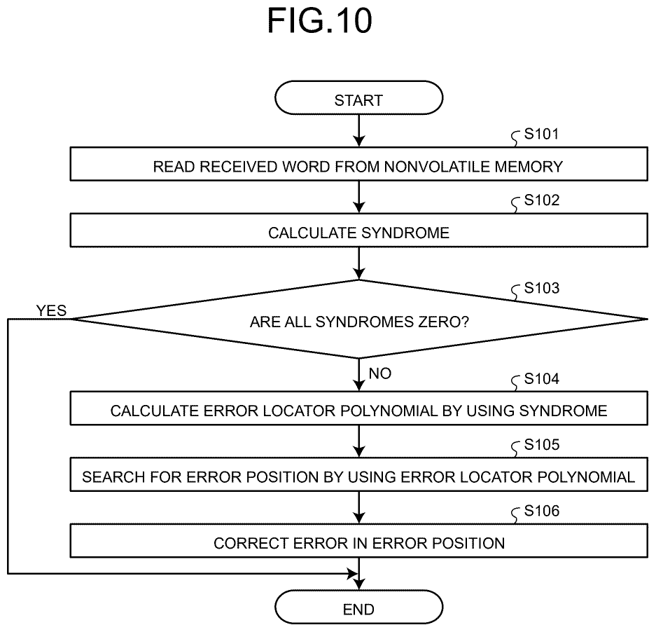

Next, a flow of decoding processing performed by the memory system 1 will be described. FIG. 10 is a flowchart illustrating an example of decoding processing according to the present embodiment.

The control unit 11 reads an error correction code from the nonvolatile memory 20, and obtains a received word (step S101). The control unit 11 also instructs the decoder 18 to start decoding.

The syndrome calculator 101 of the decoder 18 calculates a syndrome from the received word (step S102). The decoder 18 determines whether values of all of the calculated syndromes are zero (step S103).

In a case where all of the syndromes are 0 (step S103: Yes), it can be determined that there are no errors in the received word, and therefore the decoder 18 terminates the decoding processing. In a case where all of the syndromes are not 0 (step S103: No), the error locator polynomial calculator 102 calculates an error locator polynomial by using the syndromes (step S104).

The error position calculator 103 searches for an error position by using the calculated error locator polynomial (step S105). The corrector 104 corrects an error by inverting a bit in the error position obtained in the search (bit flipping) (step S106), and terminates the decoding processing.

In the present embodiment, the matrix calculator 260 calculates a linearized polynomial matrix that can be used in common by the plurality of evaluators. Accordingly, for example, each of the plurality of evaluators does not need to individually have a function for updating a linearized polynomial, and the size of a circuit (complexity) can be further reduced.

### Second Embodiment

In the first embodiment, an example where di is used as the basis {bᵢ} has been described. In the second embodiment, a basis that is different from the basis in the first embodiment is used. Specifically, in the second embodiment, α^{ip} is used as the basis {bᵢ}.

The second embodiment is different from the first embodiment in a configuration of an error position calculator. A configuration example of an error position calculator 103-2 according to the second embodiment will be described below.

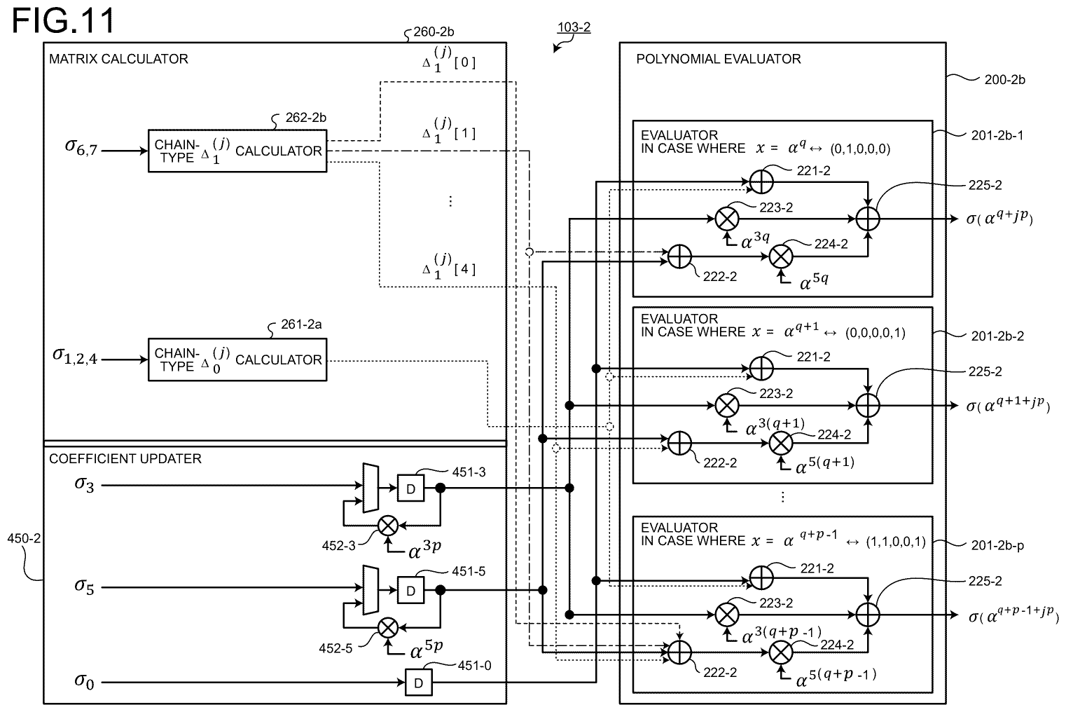

FIG. 11 is a diagram illustrating a configuration example of the error position calculator 103-2 according to the second embodiment. As illustrated in FIG. 11, the error position calculator 103-2 includes a coefficient updater 450-2, a matrix calculator 260-2b, and a polynomial evaluator 200-2b. Note that in FIG. 11, for convenience of description, some lines are illustrated in a form other than a solid line (a dotted line, an alternating long and short dashed line, or a broken line). Lines other than the solid line do not mean that no values are input, but means that a value is input to each arithmetic unit pointed by an arrow, similarly to the solid line.

The coefficient updater 450-2 is different from the coefficient updater 450-2 according to the first embodiment in that a coefficient σ other than a coefficient σ to be used to calculate the linearized polynomial matrix Δₖ (the coefficients σ₁^{(j)} that correspond to a case where i=5k+1, 5k+2, 5k+4, and 5k+8). For example, in a case where t=7, the coefficients σ₁^{(j)}, σ₂^{(j)}, σ₄^{(j)}, σ₆^{(j)}, and σ₇^{(j)} are used to calculate the linearized polynomial matrix Δₖ. Accordingly, the coefficient updater 450-2 updates and outputs σ₃^{(j)} and σ₅^{(j)} excluding these coefficients. As described above, a value of σ₀^{(j)} is not updated from an input value, and is output from the coefficient updater 450-2. Note that an example where t=7, p=3, and m=5 will be principally described below.

The matrix calculator 260-2b includes a chain-type Δ₀^{(j)} calculator 261-2a and a chain-type Δ₁^{(j)} calculator 262-2b. The chain-type Δ₀^{(j)} calculator 261-2a is a circuit that calculates the linearized polynomial matrix Δ₀^{(j)}. The chain-type Δ₁^{(j)} calculator 262-2b is a circuit that calculates the linearized polynomial matrix Δ₁^{(j)}.

The chain-type Δ₀^{(j)} calculator 261-2a and the chain-type Δ₁^{(j)} calculator 262-2b are different from the Δ₀^{(j)} calculator 261a and the Δ₁^{(j)} calculator 262b according to the first embodiment in that α^{ip} including the parallelism p as an index is used as the basis {bᵢ}, as described above. Details of the chain-type Δ₀^{(j)} calculator 261-2a and the chain-type Δ₁^{(j)} calculator 262-2b will be described later. Note that a chain type means that an arithmetic unit that has been chained to use a value calculated by an adjacent arithmetic unit is included, as described below.

The polynomial evaluator 200-2b includes p evaluators 201-2b-1 to 201-2b-p. An example in a case where parallelism p=3 will be principally described below.

In the present embodiment, similarly to the first embodiment, matrix multiplication, which is multiplication of the linearized polynomial matrix Δᵢ^{(j)} by α^{q} of binary vector expression, is performed. The linearized polynomial matrix Δᵢ^{(j)} is a m×m (in a case where m=5, 5×5) binary matrix. The element Δᵢ^{(j)}[g] of the linearized polynomial matrix Δᵢ^{(j)} is a binary vector in a g-th column of Δᵢ^{(j)} (in a case where m=5, a binary vector of five bits).

As described above, matrix multiplication corresponds to a result of addition on GF(2) of the binary vector Δᵢ^{(j)}[g] that corresponds to an index (here, g) that takes 1 when α^{q} is expressed as a vector. In other words, in addition that corresponds to matrix multiplication, a binary vector Δᵢ^{(j)}[g] that corresponds to an index that takes 1 is used.

Therefore, a circuit of each of the evaluators can be implemented in such a way that only the element Δᵢ^{(j)}[g] to be used in an arithmetic operation is connected to adders 221-2 and 222-2 and an arithmetic operation that corresponds to matrix multiplication is performed. FIG. 11 illustrates an example of each of the evaluators in the case of such implementation. Stated another way, FIG. 11 only illustrates connection to the linearized polynomial matrix Δᵢ^{(j)} or the element Δᵢ^{(j)}[g] that is to be used in an arithmetic operation performed by each of the evaluators.

Description will be provided by using the example of the evaluator 201-2b-1. The evaluator 201-2b-1 includes the adders 221-2 and 222-2, a multiplier 223-2, a multiplier 224-2, and an adder 225-2.

The adders 221-2 and 222-2 add an element that corresponds to an index (the vector expression of α^{q}) that is uniquely determined according to the evaluator 201-2b-1 from among elements (columns) of each of the linearized polynomial matrices Δ₀^{(j)} and Δ₁^{(j)}, and a coefficient (σ₀^{(j)} in the case of the adder 221-2, and σ₅^{(j)} in the case of the adder 222-2) that has been input from the coefficient updater 450-2. For example, in the example of FIG. 11, indices that correspond to the evaluator 201-2b-1 are (0, 1, 0, 0, 0), in which all except for a second element take 0. In this case, the adder 221-2 adds Δ₀^{(j)}[1], which is an element in a second column of the linearized polynomial matrix Δ₀^{(j)}, and the coefficient σ₀^{(j)}. The adder 222-2 adds Δ₁^{(j)}[1], which is an element in a second column of the linearized polynomial matrix Δ₁^{(j)}, and the coefficient σ₅^{(j)}.

As illustrated as the evaluator 201-2b-2, in a case where corresponding indices are (0, 0, 0, 0, 1), in which all except for a fifth element take 0, the adders 221-2 and 222-2 of the evaluator 201-2b-2 respectively add Δ₀^{(j)}[4] and Δ₁^{(j)}[4], which are elements in a fifth column.

As illustrated as the evaluator 201-2b-3 (corresponding to the evaluator 201-2b-p in a case where p=3), in a case where corresponding indices are (1, 1, 0, 0, 1), the adder 221-2 of the evaluator 201-2b-3 adds Δ₀^{(j)}[0], Δ₀^{(j)}[1], and Δ₀^{(j)}[4], which are elements in a first column, a second column, and a fifth column, and the adder 222-2 adds Δ₁^{(j)}[0], Δ₁^{(j)}[1], and Δ₁^{(j)}[4], which are elements in a first column, a second column, and a fifth column.

As described above, a binary vector Δᵢ^{(j)}[g] that corresponds to an index g that takes 1 when α^{q} is expressed as a binary vector is coupled to the adders 221-1 and 222-2. Stated another way, the adders 221-1 and 222-2 are configured to only add the coupled binary vector Δᵢ^{(j)}[g] (Δ₀^{(j)}[g] in the case of the adder 221-2, and Δ₁^{(j)}[g] in the case of the adder 222-2).

Note that in FIG. 11, only in a case where i=1 (Δ₁^{(j)}), coupling of each element to the adder 222-2 is illustrated, but in a case where i=0 (Δ₀^{(j)}), similarly, only an element to be used in an arithmetic operation is coupled to the adder 221-2.

The multiplier 223-2 multiplies the coefficient σ₅^{(j)} that has been input from the coefficient updater 450-2 by the multiplication value α^{3q} that corresponds to the evaluator 201-2b-1. In the cases of the evaluator 201-2b-2 and the evaluator 201-2b-3, a multiplication value is replaced with α^{3(q+1)} and α^{3(q+2)}.

The multiplier 224-2 multiplies an additional result of the adder 222-2 and the multiplication value α^{5q} that corresponds to the evaluator 201-2b-1. In the cases of the evaluator 201-2b-2 and the evaluator 201-2b-3, a multiplication value is replaced with α^{5(q+1)} and α^{5(q+2)}.

The adder 225-2 adds an additional result of the adder 221-2, a multiplication result of the multiplier 223-2, and a multiplication result of the multiplier 224-2.

Note that the evaluator 201-2b-1 may include a comparator circuit (corresponding to the comparator circuit 204) that outputs 1 in a case where an output of the adder 225-2 is 0, and outputs 0 in a case where the output is not 0, although this is omitted in FIG. 11.

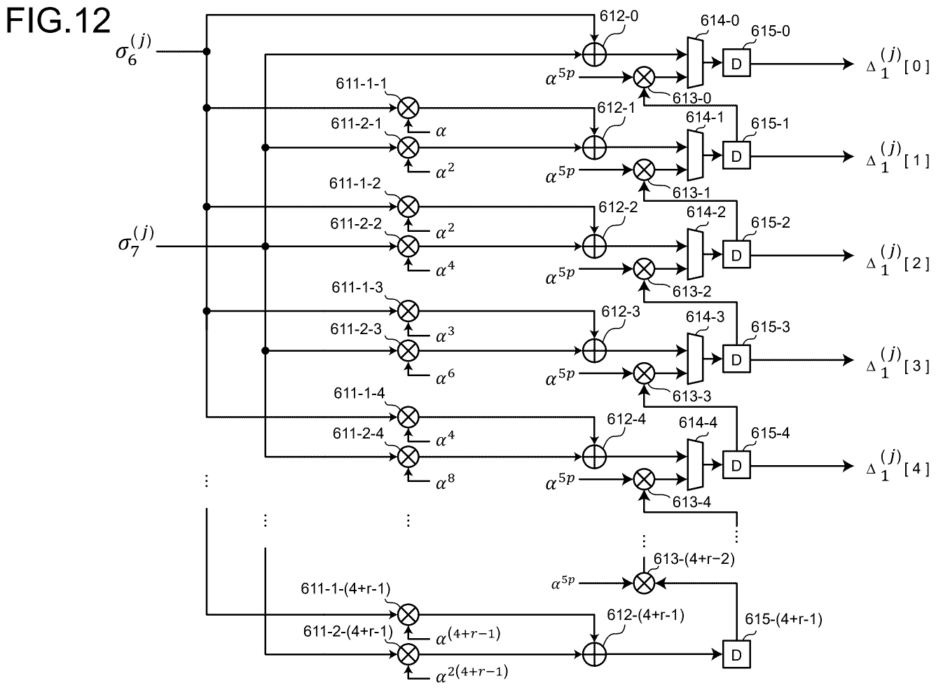

FIG. 12 is a diagram illustrating a configuration example of the chain-type Δ₁^{(j)} calculator 262-2b. The chain-type Δ₁^{(j)} calculator 262-2b includes adders 612-0 and 612-g, multipliers 611-1-g and 611-2-g, a multiplier 613-f, a selector 614-f, and a register 615-e. g is an integer that takes a value of 1 to 4+r−1. f is an integer that takes a value of 0 to 4+r−2. e is an integer that takes a value of 0 to 4+r−1. r indicates the number of cycles, as described above, and is calculated in such a way that r=ceiling(n/p).

The adders 612-0 and 612-g and the multipliers 611-1-g and 611-2-g have configurations that are similar to configurations in the Δ₁^{(j)} calculator 262b according to the first embodiment, and therefore the same reference signs are given, and description is omitted.

The multiplier 613-f multiplies the multiplication value α^{5p} (a fourth multiplication value) by a value stored in a register 615-(f+1) (a second multiplier). The value stored in the register 615-(f+1) corresponds to a value that has been calculated in a preceding cycle by an arithmetic unit (a multiplier 613-(f+1)) that is adjacent to the multiplier 613-f.

The selector 614-f selects an addition result of the adder 612-f in cycle 0 (j=0), and selects a multiplication result (a fourth multiplication result) of the multiplier 613-f in cycle 1 and cycles that follow (j=1 to r, second or more cycles).

The registers 615-0 to 615-(4+r−2) store a selection result of the selector 614-f. The register 615-(4+r−1) stores an addition result of the adder 612-(4+r−1).

Grounds that the matrix Δ₁^{(j)} can be calculated by using the chain-type Δ₁^{(j)} calculator 262-2b of FIG. 12 will be described.

In a case where substitution processing in a certain cycle has been performed by using the error locator polynomial σ(x) of Formula (23), in the next cycle, x is replaced with xα^{p}, and substitution processing is performed. Formula (25) described below corresponds to a formula obtained by transforming Formula (23) in which x has been replaced with xα^{p}.

$$σ ( x {α}^{p} ) = {x}^{3} ( {σ}_{3} {α}^{3 p} ) + \{ {σ}_{0} + {\sum }_{i = 0}^{m - 1} {x}_{i} \begin{matrix}( {b}_{i} & {( {b}_{i} )}^{2} & {( {b}_{i} )}^{4} ) ( \begin{matrix}{σ}_{1} {α}^{p} \\ {σ}_{2} {α}^{2 p} \\ {σ}_{4} {α}^{4 p}\end{matrix} ) \}\end{matrix} + {x}^{5} \{ ( {σ}_{5} {α}^{5 p} ) + {\sum }_{i = 0}^{m - 1} {x}_{i} \begin{matrix}( {b}_{i} & {( {b}_{i} )}^{2} ) ( \begin{matrix}{σ}_{6} {α}^{6 p} \\ {σ}_{7} {α}^{7 p}\end{matrix} ) \}\end{matrix} \qquad ( 25 )$$

In the second embodiment, it is assumed that the basis {bᵢ} is α^{ip}. If this basis α^{ip} is used, Formula (25) can be transformed as described in Formula (26) described below.

$$σ ( x {α}^{p} ) = {x}^{3} ( {σ}_{3} {α}^{3 p} ) + \{ {σ}_{0} + {\sum }_{i = 0}^{m - 1} {x}_{i} ( \begin{matrix}{α}^{ip} & {( {α}^{ip} )}^{2} & {( {α}^{ip} )}^{4}\end{matrix} ) ( \begin{matrix}{σ}_{1} {α}^{p} \\ {σ}_{2} {α}^{2 p} \\ {σ}_{4} {α}^{4 p}\end{matrix} ) \} + {x}^{5} \{ ( {σ}_{5} {α}^{5 p} ) + {\sum }_{i = 0}^{m - 1} {x}_{i} ( \begin{matrix}{α}^{ip} & {( {α}^{ip} )}^{2}\end{matrix} ) ( \begin{matrix}{σ}_{6} {α}^{6 p} \\ {σ}_{7} {α}^{7 p}\end{matrix} ) \} \qquad ( 26 )$$

$$= {x}^{3} ( {σ}_{3} {α}^{3 p} ) + \{ {σ}_{0} + {\sum }_{i = 0}^{m - 1} {x}_{i} ( \begin{matrix}{α}^{( i + 1 ) p} & {( {α}^{( i + 1 ) p} )}^{2} & {( {α}^{( i + 1 ) p} )}^{4}\end{matrix} ) ( \begin{matrix}{σ}_{1} \\ {σ}_{2} \\ {σ}_{4}\end{matrix} ) \} + {x}^{5} \{ ( {σ}_{5} {α}^{5 p} ) + {\sum }_{i = 0}^{m - 1} {x}_{i} {α}^{5 p} ( ( \begin{matrix}{α}^{( i + 1 ) p} & {( {α}^{( i + 1 ) p} )}^{2}\end{matrix} ) ( \begin{matrix}{σ}_{6} \\ {σ}_{7}\end{matrix} ) ) \}$$

$$= {x}^{3} ( {σ}_{3} {α}^{3 p} ) + \{ {σ}_{0} + {\sum }_{i = 0}^{m - 1} {x}_{i} {Δ}_{0} [ i + 1 ] \} + {x}^{5} \{ ( {σ}_{5} {α}^{5 p} ) + {\sum }_{i = 0}^{m - 1} {x}_{i} ( {α}^{5 p} {Δ}_{1} [ i + 1 ] ) \}$$

For example, xᵢ(α^{5p}Δ₁[i+1]) in Formula (26) corresponds to multiplication performed by the multiplier 613-f. “i+1” corresponds to the use of a value that has been calculated by an adjacent arithmetic unit in the preceding cycle. Note that the multiplication result from the adjacent arithmetic unit is described as α^{5p} because of the chain-type Δ₁^{(j)} calculator, but α^{5kp} is multiplied in the case of a chain-type Δₖ^{(j)} calculator.

Note that the chain-type Δ₀^{(j)} calculator 261-2a can be implemented by changing the Δ₀^{(j)} calculator 261a according to a method that is similar to a method of changing the Δ₁^{(j)} calculator 262b to the chain-type Δ₁^{(j)} calculator 262-2b.

The updated coefficients σ₆^{(j)} and σ₇^{(j)} are input to the Δ₁^{(j)} calculator 262b according to the first embodiment (FIG. 9) in each cycle. In contrast, in the case of the chain-type Δ₁^{(j)} calculator 262-2b according to the present embodiment, after the coefficients σ₆^{(j)} and σ₇^{(j)} have been input in a first cycle (cycle 0), the coefficients σ₆^{(j)} and σ₇^{(j)} do not need to be input. Instead, the chain-type Δ₁^{(j)} calculator 262-2b calculates the matrix Δ₁^{(j)} by using a calculation result in the preceding cycle, in the cycles that follow (cycle 1 to cycle r−1).

Accordingly, the numbers of multipliers and adders to be used for calculation in a first cycle are respectively 2(m−1) and m, and are the same as the numbers according to the first embodiment. In contrast, in the second or more cycles, only (m+r−2) multiplies (the multipliers 613-0 to 613-(4+r−2)) (in a case where m=5, (4+r−1) multipliers) perform an operation such way that the linearized polynomial matrix Δ₁^{(j)} can be calculated. Accordingly, power consumption can be reduced in comparison with the first embodiment.

As described above, the present embodiment can reduce the size of a circuit to be used in processing for searching for a root of an error locator polynomial by using the Chien search or the like. Stated another way, it is possible to reduce the size of an arithmetic circuit to be used in an arithmetic operation such as decoding processing.

It is an object of the embodiments described herein to reduce the size of an arithmetic circuit to be used in an arithmetic operation such as decoding processing.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An arithmetic circuit comprising:
a matrix calculator configured to calculate one or more matrices that correspond to one or more linearized polynomials included in one or more affine polynomials obtained by decomposing an error locator polynomial for an error correction code having a code length of n bits, n being an integer of 2 or more; and
p or more evaluators, p being an integer that satisfies 1≤p<n, configured to:
calculate, for each of the one or more matrices, a first multiplication result obtained by multiplying a corresponding matrix by a first multiplication value based on a substitution value to be substituted into the error locator polynomial;
calculate, for each of one or more evaluation terms that are included in the one or more affine polynomials and are different from the one or more linearized polynomials, a second multiplication result obtained by multiplying a second multiplication value based on the substitution value by a corresponding evaluation term; and
output error position information based on a value obtained by adding the first multiplication result and the second multiplication result, wherein
the p or more evaluators calculate the error position information by using a plurality of the substitution values that are different from each other.

2. The arithmetic circuit according to claim 1, wherein
the matrix calculator includes:
a first multiplier configured to respectively multiply at least one or more target coefficients to be used to calculate the one or more matrices from among coefficients of the error locator polynomial by predetermined third multiplication values that are different according to the at least one or more target coefficients to output a plurality of third multiplication results; and
an adder configured to add the plurality of third multiplication results to output an addition result.

3. The arithmetic circuit according to claim 2, wherein
the p or more evaluators execute processing for substituting the substitution value in each of r cycles, r being the smallest integer greater than or equal to n/p, and
the matrix calculator further includes:
a second multiplier configured to multiply a matrix in a cycle that is one ahead by a predetermined fourth multiplication value, among second or more cycles, to output a fourth multiplication result;
a selector configured to select one of the addition result and the fourth multiplication result; and
a register configured to store a selection result of the selector, and output the selection result as each of the one or more matrices.

4. The arithmetic circuit according to claim 2, wherein
each of the one or more evaluation terms is any of one or more non-target coefficients among the coefficients of the error locator polynomial, the one or more non-target coefficients being coefficients that are different from the at least one or more target coefficients.

5. The arithmetic circuit according to claim 1, wherein
the p or more evaluators input, in parallel, a plurality of the substitution values different from each other into the error locator polynomial to calculate the error position information.

6. The arithmetic circuit according to claim 1, wherein
the error correction code is a Bose-Chaudhuri-Hocquenghem (BCH) code or a Reed-Solomon (RS) code.

7. A memory system comprising:
a nonvolatile memory; and
a memory controller configured to write an error correction code to the nonvolatile memory, the error correction code having a code length of n bits, n being an integer of 2 or more, wherein
the memory controller includes an arithmetic circuit configured to:
read the error correction code from the nonvolatile memory;
calculate a syndrome by using, as a received word, the read error correction code;
determine a coefficient of an error locator polynomial based on the syndrome; and
output error position information by using the coefficient,
the arithmetic circuit includes:
a matrix calculator configured to calculate one or more matrices that correspond to one or more linearized polynomials included in one or more affine polynomials obtained by decomposing an error locator polynomial for the error correction code having the code length of n bits; and
p or more evaluators, p being an integer that satisfies 1≤p<n, configured to:
calculate, for each of the one or more matrices, a first multiplication result obtained by multiplying a corresponding matrix by a first multiplication value based on a substitution value to be substituted into the error locator polynomial;
calculate, for each of one or more evaluation terms that are included in the one or more affine polynomials and are different from the one or more linearized polynomials, a second multiplication result obtained by multiplying a second multiplication value based on the substitution value by a corresponding evaluation term; and
output error position information based on a value obtained by adding the first multiplication result and the second multiplication result, and
the p or more evaluators calculate the error position information by using a plurality of the substitution values that are different from each other.

8. The memory system according to claim 7, wherein
the matrix calculator includes:
a first multiplier configured to respectively multiply at least one or more target coefficients to be used to calculate the one or more matrices from among coefficients of the error locator polynomial by predetermined third multiplication values that are different according to the at least one or more target coefficients to output a plurality of third multiplication results; and
an adder configured to add the plurality of third multiplication results to output an addition result.

9. The memory system according to claim 8, wherein
the p or more evaluators execute processing for substituting the substitution value in each of r cycles, r being the smallest integer greater than or equal to n/p, and
the matrix calculator further includes:
a second multiplier configured to multiply a matrix in a cycle that is one ahead by a predetermined fourth multiplication value, among second or more cycles, to output a fourth multiplication result;
a selector configured to select one of the addition result and the fourth multiplication result; and
a register configured to store a selection result of the selector, and output the selection result as each of the one or more matrices.

10. The memory system according to claim 8, wherein
each of the one or more evaluation terms is any of one or more non-target coefficients among the coefficients of the error locator polynomial, the one or more non-target coefficients being coefficients that are different from the at least one or more target coefficients.

11. The memory system according to claim 7, wherein
the p or more evaluators input, in parallel, a plurality of the substitution values different from each other into the error locator polynomial to calculate the error position information.

12. The memory system according to claim 7, wherein
the error correction code is a Bose-Chaudhuri-Hocquenghem (BCH) code or a Reed-Solomon (RS) code.

13. A method of controlling a nonvolatile memory, the method comprising:
storing an error correction code in the nonvolatile memory, the error correction code having a code length of n bits, n being an integer of 2 or more;
reading the error correction code from the nonvolatile memory;
calculating a syndrome by using, as a received word, the read error correction code;
determining a coefficient of an error locator polynomial based on the syndrome;
calculating one or more matrices that correspond to one or more linearized polynomials included in one or more affine polynomials obtained by decomposing the error locator polynomial for the error correction code having the code length of n bits; and
causing each of p or more evaluation circuits to, p being an integer that satisfies 1≤p<n:
calculate, for each of the one or more matrices, a first multiplication result obtained by multiplying a corresponding matrix by a first multiplication value based on a substitution value to be substituted into the error locator polynomial;
calculate, for each of one or more evaluation terms that are included in the one or more affine polynomials and are different from the one or more linearized polynomials, a second multiplication result obtained by multiplying a second multiplication value based on the substitution value by a corresponding evaluation term; and
output error position information based on a value obtained by adding the first multiplication result and the second multiplication result, wherein
a plurality of the substitution values that are different from each other are used in the p or more evaluation circuits.

14. The method according to claim 13, wherein
the calculating the one or more matrices includes:
respectively multiplying at least one or more target coefficients to be used to calculate the one or more matrices from among coefficients of the error locator polynomial by predetermined third multiplication values that are different according to the at least one or more target coefficients to output a plurality of third multiplication results; and
adding the plurality of third multiplication results to output an addition result.

15. The method according to claim 14, wherein
a processing for substituting the substitution value is executed in each of r cycles, r being the smallest integer greater than or equal to n/p, and
the calculating the one or more matrices matrix includes:
multiplying a matrix in a cycle that is one ahead by a predetermined fourth multiplication value, among second or more cycles, to output a fourth multiplication result;
selecting, by a selector, one of the addition result and the fourth multiplication result; and
storing, by a register, a selection result of the selector and outputting the selection result as each of the one or more matrices.

16. The method according to claim 14, wherein
each of the one or more evaluation terms is any of one or more non-target coefficients among the coefficients of the error locator polynomial, the one or more non-target coefficients being coefficients that are different from the at least one or more target coefficients.

17. The method according to claim 13, wherein
a plurality of the substitution values different from each other into the error locator polynomial to calculate the error position information are, in parallel, input to the p or more evaluation circuits.

18. The method according to claim 13, wherein
the error correction code is a Bose-Chaudhuri-Hocquenghem (BCH) code or a Reed-Solomon (RS) code.
